(19) United States
(12) Patent Application Publication
(10) Pub. No.: US 2007/0011610 A1
(43) Pub. Date: Jan. 11, 2007

(54) Customized Mobile Device Interface System And Method

(75) Inventors: Hansmeet Sethi, Seattle, WA (US); Surjit S. Sethi, St. Louis, MO (US)

Correspondence Address: HANSMEET SETHI, 410 BROADWAY E., SUITE 341, SEATTLE, WA, 98102, US

(73) Assignee: ONSKREEN INC., Seattle, WA (US)

(21) Appl. No.: 11/456,187

(22) Filed: Jul. 8, 2006

Related U.S. Application Data
(60) Provisional application No. 60/595,492, filed on Jul. 11, 2005.

(51) Int. Cl. G06F 3/00

(52) U.S. Cl. 715/700

(57) ABSTRACT

The idle screen of a mobile device is enhanced to show information of interest to the user. The information is updated regularly in the background and always provides up to date information for the user without requiring the user to navigate the device or network to locate the information. The information is displayed on the idle screen, enabling the user to always have access to it.

### CROSS-REFERENCE TO RELATED APPLICATIONS

This application claims the benefit of PPA Ser. No. 60/595492, filed Jul. 11, 2005 by the present inventor.

### BACKGROUND OF INVENTION

1. Field of Invention

The present invention relates to the field of mobile device interfaces and, more particularly to the customizing of an idle screen of the mobile device.

2. Prior Art

As mobile devices, particularly cellular phones, become more capable, one of the problems facing users of the mobile devices and network service providers is how to allow users to access content, services, and capabilities of the device quickly and easily.

As the complexity of native mobile device services increase, mobile devices have implemented multiple layer menu systems which users must navigate to access native mobile device functions. For example, to access the a specific function of the device such as the Short Message Service inbox, the user may have to navigate on average 2 to 3 levels of menu hierarchy before reaching the intended device function. This can often be confusing and tedious for the user. This frustration is increased in the case of native functions on the device which the user checks often, up to 2-3 times an hour.

In addition, mobile devices increasingly allow users to access content and services available via a mobile communication network. This access is frequently enabled via an internet browser installed on the mobile device, referred to as a browser based access model. Access to content via the browser based access model often frustrates and hinders users' ability to access the content. For example, typical access to a network resource may involve: (i) navigating to the top level menu of the hierarchy; (ii) navigating the menu structure to locate the browser application; (iii) launching the browser application; (iv) entering the location of the content, via URL, using the mobile device's numeric keypad; (v) waiting up to 10 seconds for the network data connection to be initiated and data to be downloaded. This process is slow, frustrating and confusing for the user.

Current mobile devices are shipped to consumers with a standard default interface. This is the interface that is displayed to the user upon powering on the phone, ending a voice conversation, etc. . . Essentially, this interface is displayed to the user in the device idle state, when the user is not performing any other action.

Currently, the ability of users and network service providers to customize the idle screen of the mobile device has been limited. A softkey is a specific device function which can be accessed via a dedicated hardware button from the idle screen. Typically, users are limited to configuring the softkey of the mobile device from internal menus of the device. However, the functions the softkey can access are limited to native device functions.

Users have none or limited ability to configure the mobile device to provide updated information on the idle screen of the mobile device. The current option available to the user is to navigate to the source of the network content via the browser based access method described above to view the current information. Only at that point can the user know if the information has been updated. As discussed above, the process of browser based access to the information is frustrating for users.

The network service provider's ability to customize the idle screen of the device is limited to the capabilities of the device at the time of sale. Some mobile devices provide limited ability to customize graphics and the softkey of the device at the time of sale. Currently, there is no method by which the network service provider or user can extend the capabilities of the idle screen beyond those available on the device at the time of manufacturing.

In addition, there is no ability to combine local device resource access, such as access to messaging inbox and recent call list, and network based content resources, such as content from websites and network content servers, in one unified interface on the idle screen of the mobile device.

Attempts have been made previously at improving accessibility from the idle screen of the mobile device. EP 891066 to Nokia Mobile Phones Ltd. provides the approach placing the most used functions of the device into a menu list on the idle screen of the device. This method does not allow the user to configure the content, services, or native functions that are most important to them. In addition, this method provides no updating of network based content directly on the idle screen for the user to preview.

Reference may also be made to patent application Ser. No. 10/913,585 to Mobile (R & D) Ltd. which discusses user customized idle screens of mobile devices. This method limits the user to native device function access from the idle screen. This method fails to allow the user to customize the idle screen with content from the network which is cached on the device and able to preview on the idle screen.

Reference may also be made to patent application Ser. No. 10/451,500 Forsyth which discusses customizing the idle screen with content from the network. This patent fails to provide a method by which mobile devices without built-in capability to provide customized idle screens can be enhanced. My patent provides users and network service providers the ability to extend mobile devices, without pre-existing idle screen functionality, to be customized with efficient access to native device functions, network content sources, and cached content from defined network sources to be easily previewed and accessed by the user.

### SUMMARY

The present disclosure is directed to a system and corresponding methods that facilitates: (i) enabling a customized idle screen on a mobile device; (ii) allowing for user and network service provider customization of the idle screen; and (iii) enabling access to both native device functions and remote sources of information of interest.

### DRAWINGS—FIGURES

The invention will be described with reference to the accompanying drawings, in which:

FIG. 1 is a standard mobile phone with default idle interface and customized idle interface.

FIGS. 2-4 are schematic flow charts of enhancing the default idle interface with a customized idle interface.

FIGS. 5 and 6 are schematic images showing a customized idle interface displaying content from remote information providers.

FIG. 7 is a standard mobile phone with a customized idle interface and exemplary system environment.

FIG. 8 is a schematic flow chart of retrieving content from remote information sources from a mobile device.

### DRAWINGS—REFERENCE NUMERALS

111—standard mobile device

112—standard idle interface shipped with an unmodified mobile device

113—application software

114—customized idle interface

511—customized idle interface data source title

512—customized idle interface data source preview

611—customized idle interface data source detail

711—communication network

712—remote information provider

### DETAILED DESCRIPTION

An electronic system and corresponding methods, according to an embodiment of the present invention, facilitate and provide a method and system for enhancing the default interface of a mobile device with a customized idle interface (“CII”).

In the following, numerous specific details are set forth to provide a thorough description of various embodiments of the invention. Certain embodiments of the invention may be practiced without these specific details or with some variations in detail. In some instances, features not pertinent to the novelty of the system are described in less detail so as not to obscure other aspects of the invention.

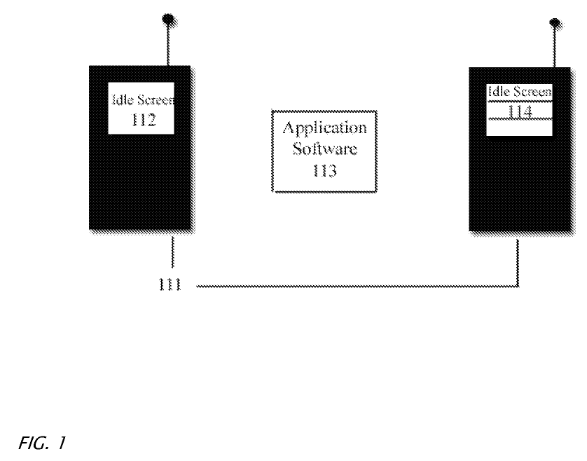

Referring to the drawings, FIG. 1 illustrates an exemplary system environment in which the present invention may operate. In accordance with one aspect of the invention, the environment comprises a mobile device 111 and a default idle interface 112 on the mobile device. Application software 113 is implemented to enable enhancing the default idle interface to the CII 114.

In some embodiments, the CII is built using application development standards to function on mobile application execution environments. In some embodiments, there are few or no requirements for proprietary mobile handsets or networks. Common application execution environments include Symbian, Java 2 Mobile Edition (“J2ME”), Microsoft Smartphone and the like.

Installation: The CII can be installed on the mobile device in a number of ways, including:
(1) Local connectivity—using Bluetooth, infrared, or similar short-range communication mechanism, an installable file can be transmitted from a Personal Computer or another mobile device to the mobile device. Once this file is on the mobile device, it can be installed to become active.
(2) Mobile network—Using a mobile network (GSM, CDMA, etc . . . ) the mobile device can download an installable file over the air. Once this file is on the mobile device, it can be installed to become active.
(3) Pre load—handset manufacturers can pre load the CII into memory of the device during the manufacturing process. Once pre loaded into the memory, the CII is present on the device.

In some embodiments, the application software must manage various aspects of the mobile device in order to provide the CII and ensure the CII is displayed at appropriate times. The mobile device components interacted with include:
(1) Window server—a window is a viewable area of the screen of the mobile device. The window server controls which windows are displayed on the foreground of the mobile device screen.
(2) Event server—an event is either a user generated, network generated, or device generated action. Examples of events are key presses, incoming phone calls, powering on the mobile device, etc . . . The event server manages all the events.
(3) Status server—a status server monitors and controls aspects of the mobile device function. These include battery metering, signal capture/management, local connectivity, etc . . .
(4) Configuration server—a configuration server manages pre-defined, and user-configurable configuration settings of the mobile device
(5) Process server—a process server manages processes and threads (as well as launching and stopping) currently executing threads of execution on the mobile device.

Displaying the CII:

The following section describes the method by which, in one embodiment, the application software manages interaction with the window server and event server to display the CII to the user.

Overall Flow:
(1) The mobile device is turned on.
(2) The CII is notified of the mobile device startup and requests the window server display the CII on the idle screen to the user.
(3) The CII requests that the event server notify the CII of all events.
(4) A native application is an executable program on the mobile device, such as the messaging application, phonebook, etc . . . The event server notifies the CII that the native application has been launched.
(5) The CII requests that the window server display the native application.
(6) The event server notifies the CII that the native application has exited.
(7) The CII requests that the window server display the CII to the user.

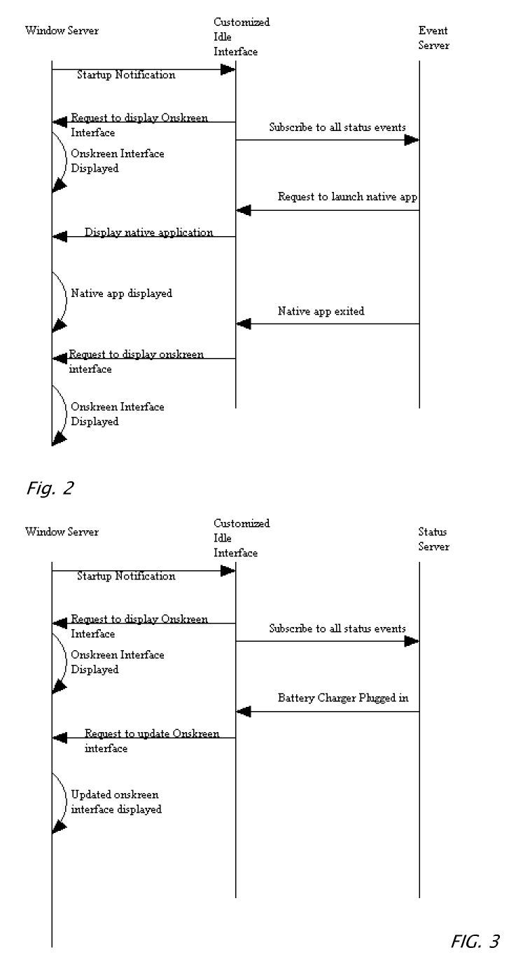

The flow and mechanism are illustrated schematically in FIG. 2.

Maintaining current mobile device status on CII:

The following section describes the method by which, in one embodiment, the application software manages the interaction with the status server to keep the CII updated with the current mobile device status.

Overall Flow:
(1) The mobile device is turned on.
(2) The CII is notified of the mobile device startup and requests the status server provide notifications of all status events.
(3) The status server detects a status update, in this example, the battery charger is plugged in.
(4) The status server informs the CII of the updated status.
(5) The CII requests the window server to update the display. The battery charging image is displayed to the user.

The flow and mechanism are illustrated schematically in FIG. 3.

Managing incoming phone call:

The following section describes the method by which, in one embodiment, the application software manages an incoming phone call.

Overall Flow:
(1) The CII is displayed to the user when a phone call is received.
(2) The event server informs the window server of the incoming call.
(3) The window server informs the CII of an incoming phone call.
(4) A phone application is an executable program which manages all telephony activity on the mobile device. The CII requests the window server to display the phone application to the user.
(5) The phone call is disconnected.
(6) If the CII was displayed to the user when the call was received, the CII is displayed once again to the user.

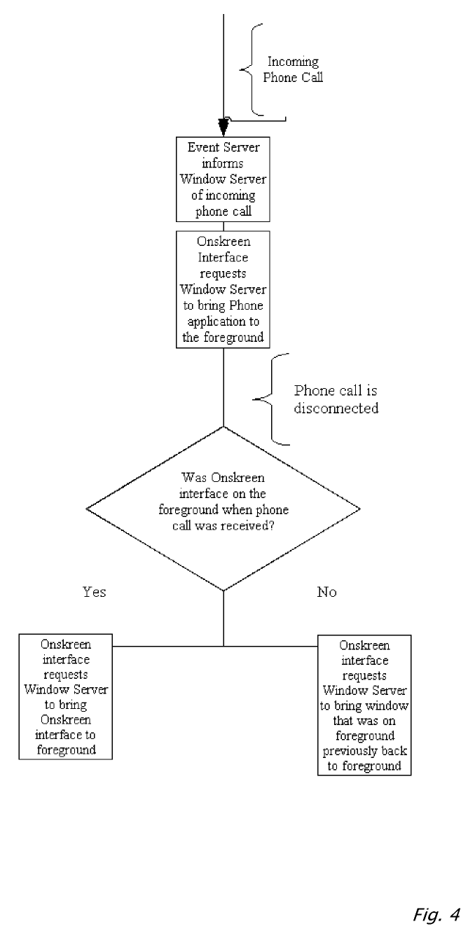

The flow and mechanism are illustrated schematically in FIG. 4.

Content in this case is described as information of relevant interest to the user. The content can be of any type—news, sports, weather, shopping catalogs, etc . . .

Providing the content accessible and viewable via the CII is advantageous for the following reasons:
(1) No searching—no navigation and search through menus is required. The content is always available on the idle screen of the mobile device.
(2) No waiting—the content is periodically cached and updated by the application software. There is no need to search for and wait for the content to be loaded as described in the browser based model.
(3) Simplicity—the user has no need to learn the different menu structures and connection mechanisms of the mobile device, as the content of interest to them is immediately available on the CII.

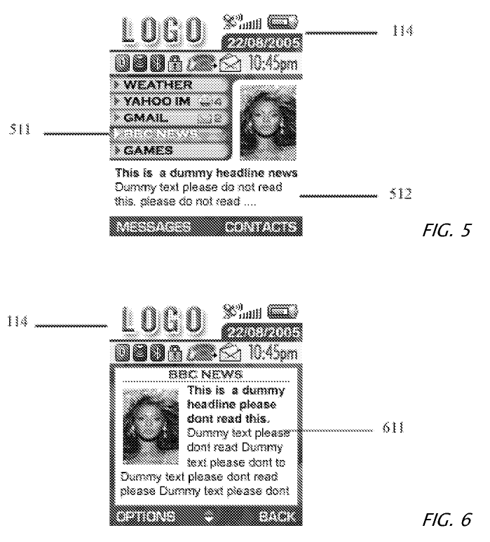

In one or more embodiments, the CII may resemble FIG. 5. The CII has been customized by the user to show content of interest. A content group is a logical module of content that the user selects as of interest. The content group may be any of news, sports, weather, etc . . . 511 represents a title of the content group which the user has chosen. 512 represents a preview of a currently selected item of the content group. The preview provides a summary of the content for the user. This view of the CII gives the user the ability to quickly navigate through the content groups they have selected and also quickly read the summary previews of the content.

It will be appreciated that the CII may also include links to and information from the native applications.

In one or more embodiments, the user may select the preview of interest using a user interface (keypad, pointing device, etc . . . ) of the mobile device, at this point the application software provides a detail view of the CII as shown in FIG. 6. 611 represents a detail view of the preview currently selected. The detail view provides all the content currently cached on the mobile device on this subject.

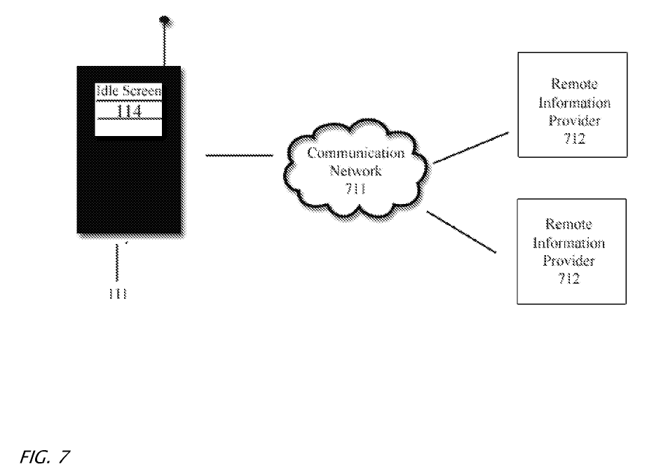

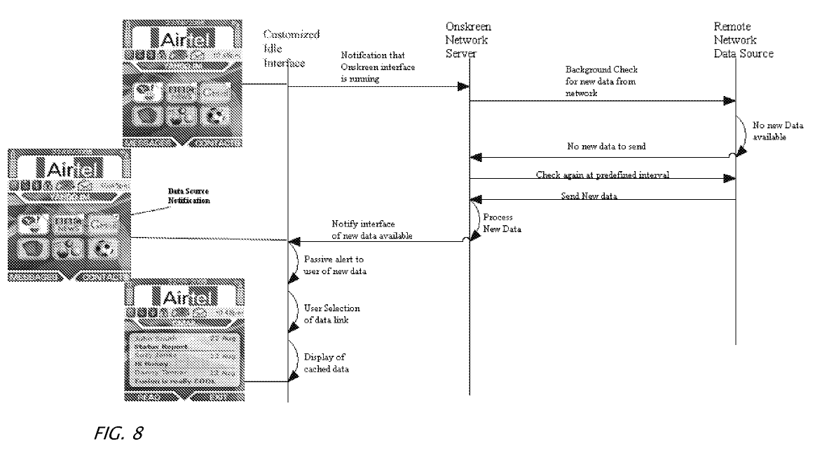

FIG. 7 represents an exemplary system environment in which the present invention may operate. The mobile device 111 with the CII 114 are connected via a communication network 711 to a remote information provider 712 which provides information for the content group(s). The terms “connected”, “coupled”, or any variant thereof, mean any connection, coupling, either direct or indirect, between two or more elements. The coupling or connection between the elements can be physical, logical, or a combination thereof.

In one embodiment, the communication network provides the medium and infrastructure for transmitting digital or analog signals between the remote information provider and the mobile device. In certain embodiments, the mobile device is a cellular telephone and the communication network is a wireless telephone network. The mobile device, remote information provider, and communications network, may be implemented over any type of mobile, fixed, wired or wireless communication technology.

One of the ordinary skill in the art will appreciate that communication network may advantageously be comprised of one or a combination of various types of networks without detracting from the scope of the invention. Such networks can, for example, comprise personal area networks (PANs), local area networks (LANs), wide area networks (WANs), public, private, or secure networks, value added networks, interactive television networks, two way cable networks, satellite networks, interactive kiosk networks, cellular networks and/or any other suitable communication networks that can provide a method of communication between mobile device and remote information provider.

In some embodiments, communication network can be part of the world wide web (i.e. the Internet). The Internet, in a well-known manner, connects millions of computers world wide through standard common addressing systems and communications protocols (e.g., Transmission control prototcol/internet protocol (TCP/IP), HyperText Transport Protocol) creating a vast communications network.

In either context, the mobile device can communicate with the remote information provider to send and receive electronic packets of information, in form of electronic requests and responses.

Updating content from remote information provider:

The following section describes the method by which, in one embodiment, the application software updates specific content from the remote information provider and make the content available to the user.

A Onskreen Network Server is part of the application software which manages communication with remote information providers.

Overall Flow:
(1) The CII informs the Onskreen Network Server that it is active.
(2) The Onskreen Network Server contacts the remote information provider to check if new content is available.
(3) If the new content is available the content is downloaded to the mobile device via the communication network.
(4) In one embodiment, the onskreen network server queries the remote information provider at a pre-defined interval for new content.
(5) When new content has been downloaded to the mobile device, the onskreen network server notifies the CII when the content has been processed and is ready to display.
(6) The CII informs the user that new content is available via a visual alert.
(7) The user then selects the content to preview.

The timings at which the onskreen network server queries the remote information provider for updated content could be controlled by various mechanisms, including:
(1) At a pre defined interval (e.g., every 20 minutes) as specified by the application software.
(2) At an interval (e.g., every 20 minutes) specified by the user.
(3) At times specified by the communication network. For example, the communication network could send a message to the mobile device at times of low network usage. This message would trigger the application software to update from the remote information provider.

The flow and mechanism are illustrated schematically in FIG. 8.

What is claimed is:

1. A method of customizing an idle screen for a mobile device, the method comprising:
selecting a plurality of information by interacting with the user interface of said mobile device;
accessing information supplied from a remote information provider; and
displaying the information as part of said idle screen of said mobile device.

2. The method of claim 1 wherein the information is updated at regular intervals.

3. The method of claim 1 wherein the information is updated at user specified intervals.

4. The method of claim 1 wherein the information is from sources selected by a user.

5. The method of claim 1 wherein the information is from sources available from a remote information provider.

6. The method of claim 1 wherein the information is from sources available on said mobile device.

7. The method of claim 1 wherein the information is from both sources available on said mobile device and from said remote information providers.

8. The method of claim 1 wherein said mobile device is a communication device which provides an application execution environment.

9. The method of claim 1 wherein said idle screen provides said user the ability to navigate through the information.

10. A computer readable medium for storing logic code executable by a microcontroller, the logic code comprising the steps of:
selecting a plurality of information by interacting with the user interface of a mobile device;
accessing information supplied from a remote information provider; and
displaying the information on an idle screen of said mobile device, whereby said mobile device provides access to information from said idle screen.

11. The computer readable medium of claim 10 wherein the information is updated at user defined intervals.

12. The computer readable medium of claim 10 wherein the logic code executes on a software execution environment of said mobile device.

13. A mobile communication device comprising:
means for displaying information from a remote information provider on an idle screen; and
means for selecting the information to display by interacting with the user interface of said mobile device.
